(19) United States
(12) Patent Application Publication
(10) Pub. No.: US 2022/0400388 A1
(43) Pub. Date: Dec. 15, 2022

(54) MOBILE NETWORK TRAILER

(71) Applicant: BearCom Group,Inc., Garland, TX (US)

(72) Inventors: MICHAEL OWEN, Garland, TX (US); CHARLA CROCHET, Garland, TX (US)

(21) Appl. No.: 17/837,340

(22) Filed: Jun. 10, 2022

Related U.S. Application Data
(60) Provisional application No. 63/209,148, filed on Jun. 10, 2021.

(51) Int. Cl. H04W 16/26; H04B 1/3822

(52) U.S. Cl. CPC H04W 16/26; H04B 1/3822; H04W 84/045

(57) ABSTRACT

Systems, vehicles, and methods for mobile network communication. A system includes a vehicle configured to be propelled in one or more directions. The system further includes one or more wireless transceivers configured to be coupled to the vehicle and communicate with one or more remote electronic devices. The system further includes a first server configured to communicate with the one or more wireless transceivers and output an action based on an input received from the one or more remote electronic devices. The system further includes one or more second servers configured to communicate with the first server, receive the outputted action, and perform the outputted action.

### CROSS-REFERENCE TO RELATED APPLICATIONS

This application claims the benefit of U.S. Provisional Application No. 63/209,148, filed on Jun. 10, 2021, which is incorporated by reference herein in their entireties.

### FIELD OF THE INVENTION

The present invention relates generally to systems, vehicles, and methods for providing mobile network communication.

### BACKGROUND OF THE INVENTION

There are circumstances that require network communication in rural, remote, and/or off-the-grid locations. For example, such circumstances may include expeditions, excavations, surveying, and constructions. Additionally, there are circumstances where a large number of people and electronic devices are present in a given location where wireless networks are overloaded and, as a result, network communications suffer from lags, disconnections from networks, or inability to connect to the networks. For example, such circumstances may include concerts, festivals, sporting events, hotels, and tournaments. Further, these gatherings may be held or located in a rural, remote, and/or off-the-grid location where network infrastructure is sparse or non-existent, which may further contribute to network connectivity issues. In such circumstances, professional staff, event organizers, employees, and/or others, which may include customers, guests, and participants, may need wireless network connection to operate various electronic devices. As such, there is a need for systems, vehicles, and methods that provide mobile network communication in these circumstances.

The background description disclosed anywhere in this patent application includes information that may be useful in understanding the present disclosure. It is not an admission that any of the information provided herein is prior art or relevant to the present claims, or that any publication specifically or implicitly referenced is prior art.

### SUMMARY OF THE PREFERRED EMBODIMENTS

In accordance with a preferred embodiment, the disclosure is embodied in a system. The system includes a vehicle. The vehicle is configured to be propelled in one or more directions. The system further includes one or more wireless transceivers configured to be coupled to the vehicle and communicate with one or more remote electronic devices. The system further includes a first server. The first server is configured to communicate with the one or more wireless transceivers and output an action based on an input received from the one or more remote electronic devices. The system further includes one or more second servers. The one or more second servers are configured to communicate with the first server, receive the outputted action, and perform the outputted action.

This and other embodiments may optionally include the following. The one or more wireless transceivers may be multiple wireless transceivers. Each of the multiple wireless transceivers may be configured to communicate via a unique wireless communication technology. The one or more remote electronic devices is multiple remote electronic devices. Each of the multiple remote electronic devices may be configured to communicate via a unique wireless communication technology. The one or more second servers may be multiple second servers, each of the multiple second servers may be a unique application server associated with a unique remote electronic device of the multiple remote electronic devices. The first server and the one or more second servers may be remote from the vehicle. The first server may be unified namespace communication server. The one or more wireless transceivers may communicate with the unified namespace communication server and the one or more second servers via a heterogeneous wireless network.

In accordance with another preferred embodiment, the disclosure is embodied in a vehicle. The vehicle includes a cabin. The vehicle further includes a plurality of wheels coupled to the cabin and configured to move the cabin in one or more directions. The vehicle further includes one or more wireless transceivers. The one or more wireless transceivers are configured to be coupled to the cabin and receive an input from one or more remote electronic devices, transmit the input to a first remote server for the first remote server to output an action based on the input, and transmit the outputted action to one or more second remote servers for the one or more second remote servers to perform the outputted action.

This and other embodiments may optionally include the following. The one or more wireless transceivers may be multiple wireless transceivers. Each of the multiple wireless transceivers may be configured to communicate via a unique wireless communication technology. The one or more remote electronic devices is multiple remote electronic devices. Each of the multiple remote electronic devices may be configured to communicate via a unique wireless communication technology. The one or more second servers may be multiple second servers, each of the multiple second servers may be a unique application server associated with a unique remote electronic device of the multiple remote electronic devices. The first server may be unified namespace communication server. The one or more wireless transceivers may communicate with the unified namespace communication server and the one or more second servers via a heterogeneous wireless network.

In accordance with yet another preferred embodiment, the disclosure is embodied in a method. The method includes receiving an input from one or more remote electronic devices by one or more wireless transceivers of a vehicle. The method further includes transmitting the input to a first remote server by the one or more wireless transceivers of the vehicle. The method further includes outputting an action based on the input by the first remote server. The method further includes transmitting the outputted action to one or more second remote servers by the first remote server. The method further includes performing the outputted action by the one or more second remote servers.

This and other embodiments may optionally include one or more of the following. The one or more wireless transceivers may be multiple wireless transceivers. Each of the multiple wireless transceivers may be configured to communicate via a unique wireless communication technology. The one or more remote electronic devices is multiple remote electronic devices. Each of the multiple remote electronic devices may be configured to communicate via a unique wireless communication technology. The one or more second servers may be multiple second servers, each of the multiple second servers may be a unique application server associated with a unique remote electronic device of the multiple remote electronic devices. The first server may be unified namespace communication server. The one or more wireless transceivers may communicate with the unified namespace communication server and the one or more second servers via a heterogeneous wireless network. The method may further include positioning the vehicle at a location without wireless network.

### BRIEF DESCRIPTION OF THE DRAWINGS

The disclosure may be more readily understood by referring to the accompanying drawings in which:

FIG. 1 is a perspective view of a mobile network vehicle in accordance with a preferred embodiment of the present disclosure;

FIG. 2 is a schematic view of a mobile network system in accordance with a preferred embodiment of the present disclosure;

FIG. 3 is a schematic view of an exemplary mobile network system in accordance with a preferred embodiment of the present disclosure; and

FIG. 4 is a flow diagram of a method for mobile network communication in accordance with a preferred embodiment of the present disclosure.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present disclosure.

The systems, vehicles, and methods described herein provide a mobile network. The mobile network may allow for various electronic devices to communicate with one or more servers and exchange data. The electronic devices may advantageously utilize a variety of wireless communication technologies. The one or more servers may exchange voice, video, and application data with the electronic devices. The created network may be localized and/or expand to a wide area. As such, the mobile network may advantageously aggregate and unify various electronic devices and various connection methods, thereby providing connectivity and data exchange across the board.

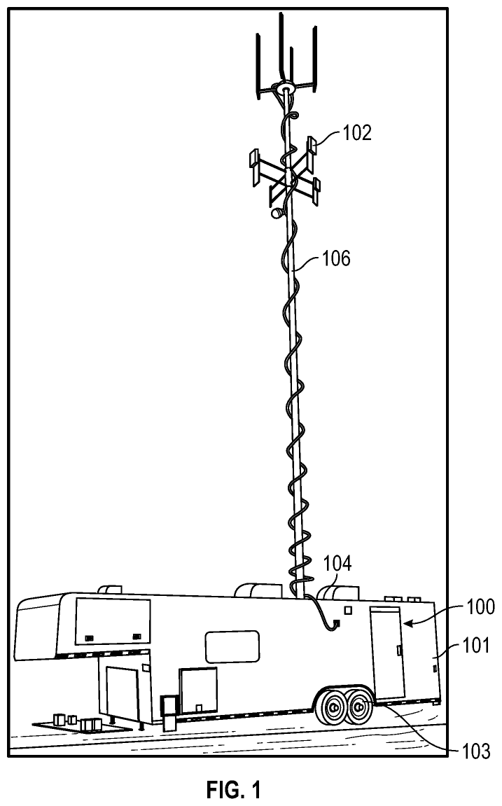

FIG. 1 is a perspective view of a mobile network vehicle 100. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a car, a sports utility vehicle (SUV), a recreational vehicle (RV), a truck, a bus, a van, a motorcycle, a boat, a plane, a drone, or another motor or battery driven vehicle. For example, the vehicle 100 may be an electric vehicle, a hybrid vehicle, a plug-in hybrid vehicle, a fuel cell vehicle, or any other type of vehicle that includes a motor/generator. In other examples, the vehicle 100 may be a carriage, a trailer, a mobile home, and/or the like, which may not be self-propelled by an engine or a motor but instead propelled by another vehicle, a person, or an animal. The vehicle 100 may have a cabin 101. The cabin 101 may receive and/or at least partially enclose a person, an object, or a permanently or temporarily fixed apparatus. The vehicle 100 may have multiple wheels 103 coupled to the cabin 101. The wheels 103 may move the cabin 101 in one or more directions. FIG. 1 depicts a trailer by example.

The vehicle 100 may have a wireless transceiver 102. The wireless transceiver 102 may transmit and receive data using conventional communication technologies such as cellular, EDGE, 3G, 4G, 5G, long term evolution (LTE), Wi-Fi®, Bluetooth®, radio frequency (RF), satellite, Infrared, Zigbee®, long rage (LoRa), and/or the like.

The wireless transceiver 102 may be coupled or attached to the vehicle 100. The wireless transceiver 102 may be permanently fixed to the vehicle 100 or removable. The wireless transceiver 102 may extend away from the vehicle 100. The wireless transceiver 102 may be disposed on an exterior 104 of the vehicle 100, partially within the vehicle 100, or completely inside the vehicle 100. The wireless transceiver 102 may have an antenna or antenna-like structure. In some examples, the wireless transceiver 102 may be attached to a pole 106. The pole 106 may position the wireless transceiver 102 at a higher altitude. The higher altitude of the wireless transceiver 102 may allow the wireless transceiver 102 to have a broader communication range. In some examples, the pole 106 may be telescoping, folding, or disassembled for transportation, storage, and/or adjustment of the height of the pole 106.

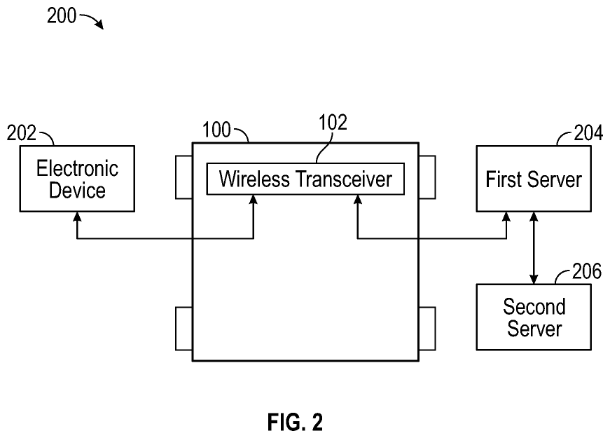

FIG. 2 is a schematic view of a mobile network system 200. The system 200 may include the vehicle 100, an electronic device 202, a first server 204, and a second server 206. The vehicle 100 may include the wireless transceiver 102.

The electronic device 202 may include a portable electronic device such as a cellular phone, a smartphone, a tablet, a laptop, a walkie-talkie, a camera, a multimedia player, and/or the like. In other examples, the electronic device 202 may include a device that utilize internet of things (IoT), such as smart home devices. In some examples, the electronic device 202 may be permanently or temporarily fixed to a location. Such devices may include surveillance cameras, doorbells, speakers, microphones, thermostats, and/or the like. The electronic device 202 may exchange data using conventional communication technologies such as cellular, EDGE, 3G, 4G, 5G, LTE, Wi-Fi®, Bluetooth®, RF, satellite, Infrared, Zigbee®, LoRa, and/or the like.

The first server 204 may communicate with the wireless transceiver 102 through a wireless or wired communication technology and output an action based on an input received from the electronic device 202. The first server 204 may be disposed in or on the vehicle 100 or may be in a remote location from the vehicle 100.

The second server 206 may communicate with the first server 204. The second server 206 may receive the action outputted by the first server 204 and perform the outputted action. The second server 206 may be disposed in or on the vehicle 100 or may be in a remote location from the vehicle 100.

For example, a user may enter an input to the electronic device 202 to play a video on an application. The input to play the video on the application may be communicated with the first server 204 through the wireless transceiver 102. The first server 204 may output an action, which may be to retrieve the selected video from a database and stream the video, for the second server 206 to process. Upon processing the action, the second server 206 may perform the action by retrieving the selected video from a database and enable the electronic device 202 to play the video.

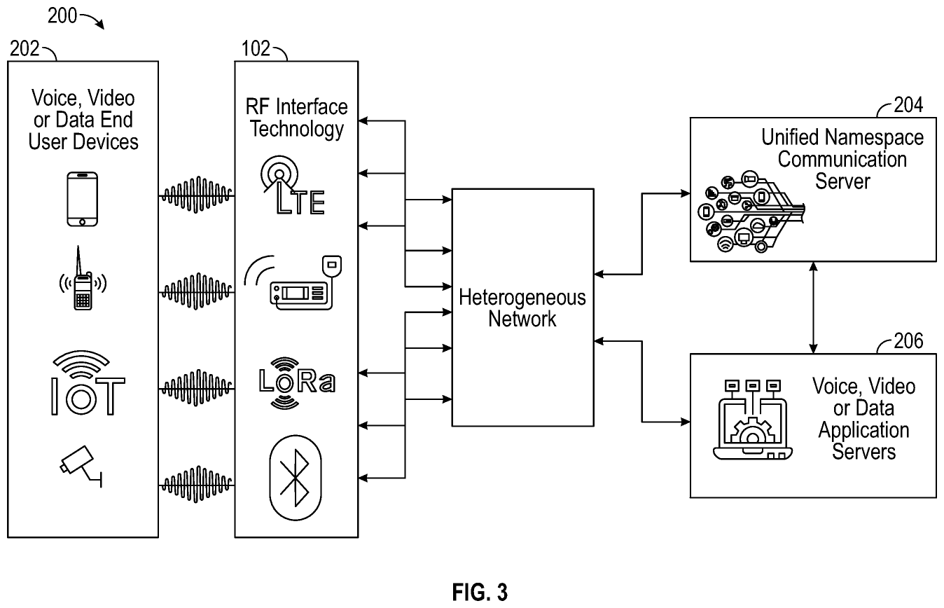

FIG. 3 is a schematic view of an exemplary mobile network system 200. The system 200 may have multiple electronic devices 202. The electronic devices 202 shown in FIG. 3 by example are a smartphone, a walkie-talkie, an IoT device, and a surveillance camera.

Each of the electronic devices 202 may communicate with each other and the wireless transceiver 102 via a unique wireless communication technology such as cellular, EDGE, 3G, 4G, 5G, LTE, Wi-Fi®, Bluetooth®, RF, satellite, Infrared, Zigbee®, LoRa, and the like. Each of the electronic devices 202 may support more than one communication technology.

The system may have multiple wireless transceivers 102. Each of the multiple wireless transceivers 102 may transmit and receive data via a unique wireless communication technology. The unique wireless communication technologies shown in FIG. 3 by example are LTE, RF, LoRa, and Bluetooth®.

The electronic devices 202, which may have differences in operating systems, hardware, and/or protocols may be connected to a network through the wireless transceivers 102. The network may be conventionally referred to as a heterogeneous wireless network (HetNet). The HetNet may link the wireless transceivers 102 to the first server 204 and the second server 206.

The first server 204 shown in FIG. 3 is a unified namespace communication server (UNCS). The UNCS may be a centralized repository of data, information, and context where the electronic devices 202 and the various applications running on the electronic devices 202 may consume and/or publish data needed for a specific action.

The second server 206 shown in FIG. 3 is a plurality of servers each being a unique application server associated with a particular electronic device 202, a voice server, and a video server. The first server 204 and the second server 206 may communicate with each other.

The UNCS may allow for different disparaged electronic devices 202 that the wireless transceivers 102 may communicate with in the HetNet to interact as an automated network. The UNCS may receive inputs from the electronic devices 202 and provide output actions that the second servers 206 may act upon. As such, the system 200 may automate processes and activities from different electronic devices 202 to behave in an interactive manner without requiring human intervention. Further, artificial intelligence, or a machine learning algorithm, may be utilized by the system 200 to supplement machine-to-machine and machine-to-people communications.

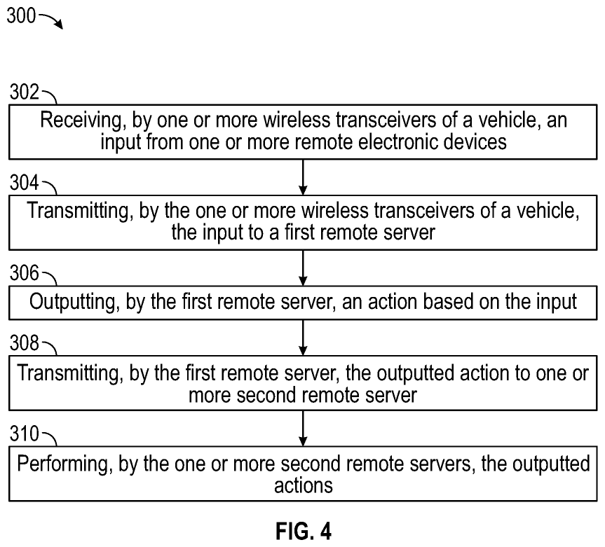

FIG. 4 is a flow diagram of a method 300 for mobile network communication. One or more components of the system 200 (see FIGS. 2-3) may be utilized to perform the steps of the method. The vehicle 100 may be driven to, positioned, or disposed at a location without or with insufficient wireless network access as part of the method 300. The method 300 may begin with block 302.

In block 302, the method 300 may include receiving an input from one or more remote electronic devices by one or more wireless transceivers of a vehicle. For example, the input may be a request to view a text message, an email, or a document stored in a cloud server.

In block 304, the method 300 may include transmitting the input to a first remote server by the one or more wireless transceivers of the vehicle. In block 306, the first remote server may output an action based on the input. For example, the action may be retrieving the text message, the email, or the document.

In block 308, the method 300 may include transmitting the outputted action to one or more second remote servers by the first remote server. In block 308, the one or more second remote servers may perform the outputted action. For example, the one or more second remote servers may retrieve the text message, the email, or the document for the one or more electronic devices to display.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A system comprising:
a vehicle configured to be propelled in one or more directions;
one or more wireless transceivers configured to be coupled to the vehicle and communicate with one or more remote electronic devices;
a first server configured to communicate with the one or more wireless transceivers and output an action based on an input received from the one or more remote electronic devices; and
one or more second servers configured to communicate with the first server, receive the outputted action, and perform the outputted action.

2. The system of claim 1 wherein the one or more wireless transceivers is a plurality of wireless transceivers, each of the plurality of wireless transceivers being configured to communicate via a unique wireless communication technology.

3. The system of claim 1 wherein the one or more remote electronic devices is a plurality of remote electronic devices, each of the plurality of remote electronic devices being configured to communicate via a unique wireless communication technology.

4. The system of claim 3 wherein the one or more second servers is a plurality of second servers, each of the plurality of second servers being a unique application server associated with a unique remote electronic device of the plurality of remote electronic devices.

5. The system of claim 1 wherein the first server and the one or more second servers are remote from the vehicle.

6. The system of claim 1 wherein the first server is a unified namespace communication server.

7. The system of claim 6 wherein the one or more wireless transceivers communicate with the unified namespace communication server and the one or more second servers via a heterogeneous wireless network.

8. A vehicle comprising:
a cabin;
a plurality of wheels coupled to the cabin and configured to move the cabin in one or more directions; and
one or more wireless transceivers configured to be coupled to the cabin and receive an input from one or more remote electronic devices, transmit the input to a first remote server for the first remote server to output an action based on the input, and transmit the outputted action to one or more second remote servers for the one or more second remote servers to perform the outputted action.

9. The vehicle of claim 8 wherein the one or more wireless transceivers is a plurality of wireless transceivers, each of the plurality of wireless transceivers being configured to communicate via a unique wireless communication technology.

10. The vehicle of claim 8 wherein the one or more remote electronic devices is a plurality of remote electronic devices, each of the plurality of remote electronic devices being configured to communicate via a unique wireless communication technology.

11. The vehicle of claim 10 wherein the one or more second remote servers is a plurality of remote second servers, each of the plurality of remote second servers being a unique application server associated with a unique remote electronic device of the plurality of remote electronic devices.

12. The vehicle of claim 8 wherein the first remote server is a unified namespace communication server.

13. The vehicle of claim 12 wherein the one or more wireless transceivers communicate with the unified namespace communication server and the one or more second remote servers via a heterogeneous wireless network.

14. A method for mobile network communication comprising:
receiving, by one or more wireless transceivers of a vehicle, an input from one or more remote electronic devices;
transmitting, by the one or more wireless transceivers of the vehicle, the input to a first remote server;
outputting, by the first remote server, an action based on the input;
transmitting, by the first remote server, the outputted action to one or more second remote servers; and
performing, by the one or more second remote servers, the outputted action.

15. The method of claim 14 wherein the one or more wireless transceivers is a plurality of wireless transceivers, each of the plurality of wireless transceivers being configured to communicate via a unique wireless communication technology.

16. The method of claim 14 wherein the one or more remote electronic devices is a plurality of remote electronic devices, each of the plurality of remote electronic devices being configured to communicate via a unique wireless communication technology.

17. The method of claim 16 wherein the one or more second remote servers is a plurality of remote second servers, each of the plurality of remote second servers being a unique application server associated with a unique remote electronic device of the plurality of remote electronic devices.

18. The method of claim 14 wherein the first remote server is a unified namespace communication server.

19. The method of claim 18 wherein the one or more wireless transceivers communicate with the unified namespace communication server and the one or more second remote servers via a heterogeneous wireless network.

20. The method of claim 14 further comprising positioning the vehicle at a location without wireless network access.
